(19) United States
(12) Patent Application Publication
(10) Pub. No.: US 2007/0083795 A1
(43) Pub. Date: Apr. 12, 2007

(54) Securised microprocessor with jump verification

(75) Inventor: Andre Kudelski, Chemin de Bellingard (CH)

Correspondence Address: HARNESS, DICKEY & PIERCE, P.L.C., P.O. BOX 8910, RESTON, VA, 20195, US

(73) Assignee: NagraCard S.A.

(21) Appl. No.: 11/544,596

(22) Filed: Oct. 10, 2006

(30) Foreign Application Priority Data
Oct. 10, 2005 (EP) 05109382.1

(51) Int. Cl. G06F 11/00

(52) U.S. Cl. 714/38

(57) ABSTRACT

The aim of the present invention is to propose a method and a device in order to avoid damages that the desynchronisation of the program counter may cause. This aim is achieved by means of a secured microprocessor comprising a program counter and an interface with a program memory containing the instructions, this microprocessor being wherein it includes a historical memory of the program counter indicating the position of the program counter at the time of the execution of the previous instruction, and an instruction verification module, this module comprising reading means of an additional piece of verification information that defines for the instruction in progress, the supposed position of the previous program counter, this verification module comprising means to compare this verification information with that originating from the historical memory and means to generate an error if the verification indicates an incompatibility.

### PRIORITY STATEMENT

This application claims benefit of priority under 35 U.S.C. §119 from European Patent Application No. EP 05109382.1 filed on Oct. 10, 2005, in the European Patent Office, the disclosure of which is incorporated herein by reference in its entirety.

### INTRODUCTION

The present invention relates to the domain of microprocessors, in particular the domain of securing the execution of the code of said microprocessor.

### STATE OF THE ART

It is well known that an instruction is made up of an opcode (or instruction identifier) and zero or several operands. The first byte of an instruction (“opcode”) plays an important role as it defines the desired function. According to the instruction, one or several complementary bytes will be necessary to form an instruction.

According to the type of processor, the size of an opcode can be 8,12, 16 or 32 bits. An opcode can also temporarily be on a greater length, for example a value of 18H for the first byte means that the second byte defines also the instruction (see instruction list of 68HC11 for example).

When a processor is desynchronised, for example due to a programming error or an external spike, it is possible that its program counter (PC) will points to a memory position that is not an opcode but an operant.

| | | | | |
|---|---|---|---|---|
| F091 | 12 2D 78 11 | LF091: | BRSET | L002D, #%01111000, LF0A6 |
| F095 | CE F3 17 | | LDX | #$F317 |
| F098 | 18 1F 00 10 0B | | BRCLR | 0, Y, #%00010000, LF0AC |

Each instruction begins with an “opcode” and can be followed by several operands. During the normal operating of the program, an instruction is loaded into the central unit, this instruction having a variable length according to the opcode. Therefore, for a simple instruction (NOP, INCA . . . ) no operant is added while for a more complicated instruction (BRCLR) four operands can be found. The system is very flexible and is based on the idea that each instruction follows another. At the end of the execution of an instruction, the following code is necessarily an opcode.

It is possible to imagine the damage caused by the anarchic execution of a program that will begin randomly, for example due to overloads or other static interference.

According to the example above, if the program counter PC is loaded with the address F093, the instruction that it will execute will be that whose opcode is 78H, namely the instruction

| | | | |
|---|---|---|---|
| F093 | 78 11 CE | ASL | @$11CEh |
| F096 | F3 17 18 | ADD | @$1718h |
| F099 | 1F 00 10 0B | BRCLR | 0, X, #00010000B, LF0AC |

The series of codes executed is completely random and uncontrollable. The consequences can be dramatic, for example the erasing of important data or transmission of enciphering keys.

### BRIEF DESCRIPTION OF THE INVENTION

The aim of the present invention is to propose a method and a device to avoid damages that a desynchronisation of the program counter could cause.

This aim is achieved by means of a secured microprocessor comprising a program counter and an interface with a program memory containing the instructions, this microprocessor being wherein it comprises a historical memory of the program counter that indicates the position of the program counter at the time of the execution of the previous instruction, and an instruction verification module, this module comprising reading means of an additional part of verification information that defines for the instruction being executed, the supposed position of the previous program counter, this verification module comprising means to compare this verification information with that originating from the historical memory, and means to generate an error if the verification indicates an incompatibility.

This verification module is directly implemented in the microprocessor and acts on the acquisition part of an instruction (“fetch”). When an instruction is read, the verification information is read at the same time. This information will allow the way in which this instruction is reached to be determined according to the thoughts of the computer programr.

The historical memory of the program counter contains information about the origin of said counter before arriving at the instruction currently being executed. This indication of the origin can, in a simplified form, simply indicate if the instruction previously executed was the instruction just above the instruction in progress (auto-increment of the program counter) or on the contrary, another instruction.

### BRIEF DESCRIPTION OF FIGURE

The invention will be better understood thanks to the detailed following description that refers to the annexed design that is given as a non-limitative example, in which:

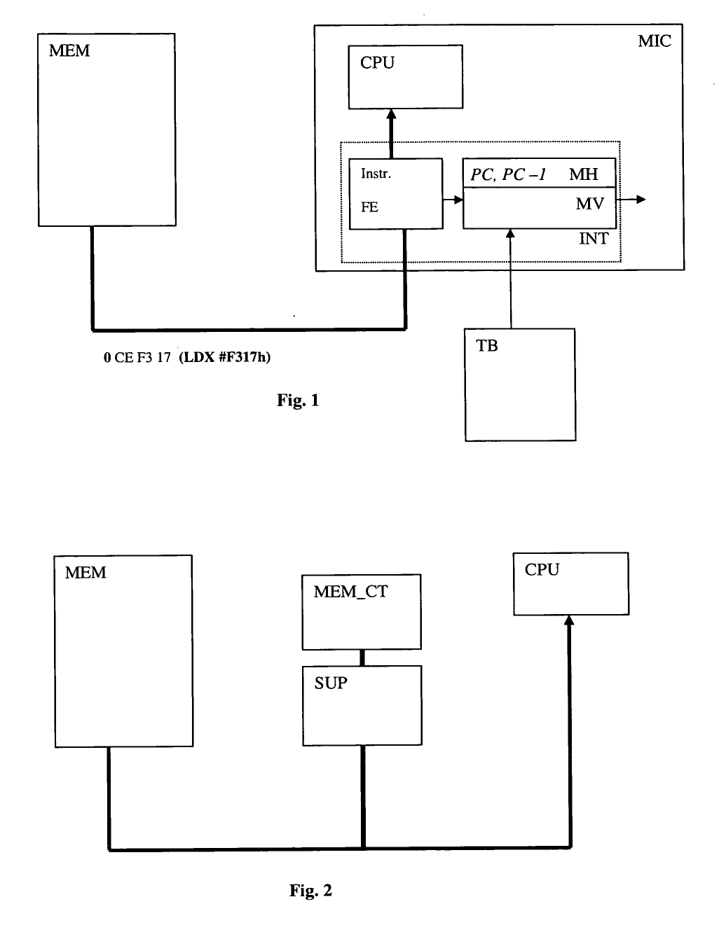

the FIG. 1 shows having an integrated verification module,

the FIG. 2 shows a processor, its memory and an independent verification module.

### DETAILED DESCRIPTION OF THE INVENTION

In the normal execution of a program; it can be considered that two types of situation exist at the time of the execution of an instruction:
it is executed just after the previous instruction
it is executed due to a jump

In the first case, the program counter increases automatically at the end of the processing of the previous instruction. We are in a continuous mode.

In the second case, the program counter is loaded by a value originating from several sources, for instance a jump (JMP), a subroutine call (JSR, BSR), a conditional jump (BHS, BRA) or an interruption entry. The instructions executed due to a jump represent a small percentage of the code. For this reason, according to one variant of the invention, the instructions dispose of a value indicating in which category they are found.

It is to be noted that an instruction that is found in the second category (authorized jump) can also be in the first category. In fact, during a loop for example, it is possible to arrive at an instruction either by means of the jump, or the normal increasing of the program counter. In the case of a first subroutine instruction, it is only possible to reach this instruction by a jump. By jump, it is meant that the program counter is arbitrary loaded with a destination address. The jump indicator can have three states, namely possible jump, prohibited jump or obligatory jump.

It is thus proposed to add a verification indication for each instruction, this indication comprising at least two states, (possible jump, impossible jump) and to add this piece of information to the executable code.

| F091 | 112 2D 78 11 | LF091: | BRSET | L002D, #%01111000, LF0A6 |
|---|---|---|---|---|
| F095 | 0CE F3 17 | | LDX | #$F317 |
| F098 | 018 1F 00 | | BRCLR | 0, Y, #%00010000, LF0AC |
| | 10 0B | | | |
| F09E | 004C | | INCA | |
| F09F | 1AB 12 | LF0AC: | ADD | #12 |

The line F09F is typically an instruction that can be executed due to the jump defined in the line F098 or on the contrary, due to the previous instruction. In a first embodiment, the jump value will be 1 for “possible jump”.

The lines F095 or F09E are on the contrary exclusively executed after the previous instruction. A jump to this address is impossible.

With respect to the line F091, in the case in which it is the entry of an interruption program, the jump is not only possible but also necessary. According to one variant of the invention, it is possible to place a 2 in place of the 1 for “necessary jump”.

In FIG. 1, the program memory MEM will contain the entirety of the program. It can be a matter of a different type of support such as ROM, RAM or Flash. The interface part INT of the processor MIC will read the instructions by means of a reading module FE. The historical memory MH contains the previous program counter (PC-1) and the current value (PC). The latter will become the previous value at the time of the next instruction.

The verification module MV extracts (or receives) the verification indication associated to the instruction in progress and compares this information with the transmitted data of the historical memory. If the instruction is valid, it will be transmitted to the central unit (CPU) for execution.

During the execution of the program, the execution context is also stored in the historical memory of the program counter, namely the modification information of the program counter. In a simplified version, this information can either be “access by auto-increment” or “access by jump”. At the time of the instruction call, the execution history is compared with the verification information. If the history indicates “access by auto-increment” and that the verification information is equal to zero (impossible jump), the instruction is valid.

If the history is equal to “access by jump” and the verification information is equal to 0 (impossible jump), the instruction is invalid.

If the historical is equal to “access by a jump” and the verification information is equal to 1 (possible jump), the instruction is valid; and if the historical indicates “access by auto-increment” and the verification information is equal to 1 (possible jump), the instruction is valid (except if the system with three states has been adopted and the verification information is of the type “access by jump necessary”.

The entirety of the verification data can be stored in another memory thus forming an execution mask. The verification information is read in this memory and compared with the behaviour of the microprocessor.

According to one embodiment, the verification information can comprise a value indicating an acceptable jump range.

| F091 | FF 12 2D 78 11 | LF091: | BRSET | L002D, #%01111000, |
|---|---|---|---|---|
| | | | | LF0A6 |
| F095 | 00 CE F3 17 | | LDX | #$F317 |
| F098 | 00 18 1F 00 | | BRCLR | 0, Y, #%00010000, |
| | 10 0B | | | LF0AC |
| F09E | 00 4C | | INCA | |
| F09F | 08 AB 12 | LF0AC: | ADD | #12 |

According to our example, the verification information is encoded on 8 bits. If the value is zero, only the execution of this instruction following the previous is accepted.

This is the case for lines F095, F098 and F09E. For line F09F, the verification information is equal to 08, namely the previous value of the program counter should not exceed a difference of 8 in relation to the current value. Therefore a window is created to limit the access to this instruction to a small range of previous program counters.

If an instruction can be reached from several starting points, the verification information will comprise the highest value. The maximum value can be reserved, namely FFh, in our example to indicate that a jump is authorized regardless of the previous value of the program counter. This situation is the case for line F091 that is the subroutine entry that forms the example disclosed above.

According to a more sophisticated method for the invention, a starting position table TB is constituted for each instruction accepting the arrival due to a jump.

This table contains all the possible starting addresses.

Table F09F

[image]

The line F09F will contain the starting address F098 according to our example. If other instructions allow this line to be accessed, their starting address will be contained in the table.

At the time of the execution of the line F09F, the first verification is carried out on the basis of the verification information. If the arrival at this instruction follows a jump, this information (originating from the historical memory) is compared with the verification information (that can be one bit in this case).

Once the arrival by jump is accepted, the verification will search the table corresponding to the instruction in progress and compare the value of the previous program counter to the values contained in the table. If the value is present, the instruction is definitively accepted. If not, an error message is generated.

These tables are generated at the time of the compilation of the program and can be stored in a memory different to the program memory, for example a memory that is only accessible to the verification module.

According to another embodiment illustrated in the FIG. 2, the processor CPU is standard, therefore not modified. All supervision operations are dedicated to a supervisor module SUP which is located on the data and address bus of the processor. Thus, at each instruction read in the memory MEM, the supervisor module verifies the current and previous program counter address. Based on the current program counter value, the supervisor module read the value of the maximum jump which is stored in the control memory MEM_CT. The difference between the current and previous program counter value is calculated and compared with the value stored in the control memory MEM_CT. If the difference is equal or smaller at the reference value, no action is made and the processor continues its program. In the contrary, an interrupt is sent to the processor.

In the case that of using a cache memory located between the microprocessor and the memory MEM, the supervisor module will be placed close to the processor so that it will not be influenced by reading instructions that will not be executed.

1. Secured microprocessor comprising a program counter and an interface with a program memory containing the instructions, this microprocessor being wherein it includes a historical memory of the program counter indicating the position of the program counter at the time of the execution of the previous instruction, and an instruction verification module, this module comprising reading means of an additional verification information that defines for the instruction in the process of being executed, the supposed position of the previous program counter, this verification module comprising means to compare this verification information with that originating from the historical memory, and means to generate an error if the verification indicates an incompatibility.

2. Secured microprocessor according to claim 1, wherein the verification indication contains at least two states, namely “access by auto-increment” or “access by jump”, and in that the historical memory contains two states, namely “access by auto-increment” or “access by jump” on the basis of the behaviour of the program counter in order to reach the instruction in progress, the verification module generates an error if the verification information indicates the state “access by auto-increment”, and the historical memory indicates the state “access by jump”.

3. Secured microprocessor according to claim 1, wherein the verification indication contains at least two states, namely “access by auto-increment” or “access by jump”, and in that the historical memory contains two states, namely “access by auto-increment” or “access by jump” on the basis of the behaviour of the program counter in order to reach the instruction in progress, the verification module accepts the current instruction if the verification information indicates the state “access by jump”, and the historical memory indicates the state “access by auto-increment”.

4. Secured microprocessor according to claim 1, wherein the verification indication contains at least two states, namely “access by auto-increase” or “access by jump”, and in that the historical memory contains two states, namely “access by auto-increment” or “access by jump” on the basis of the behaviour of the program counter in order to reach the instruction in progress, the verification module accepts the instruction in progress if the verification information indicates the state “access by jump”, and the historical memory indicates the state “access by jump”.

5. Secured microprocessor according to claim 2, wherein the verification indication contains three states, namely “access by auto-increment”, “access by jump” or “access by jump necessary”, the verification module generates an error if the verification information contains the state “access by jump necessary”, and the historical memory indicates the state “access by auto-increment”.

6. Secured microprocessor according to claim 1, wherein if the verification indication contains “access by jump”, and in that the historical memory contains the state “access by jump”, the verification module, prior to the acceptance of the instruction, comprises reading means of a table comprising, for the instruction in progress, the previous authorized program counter(s) and verifies if the previous program counter contained in a historical module is present in this list.

7. Supervisor module for microprocessor, comprising an access to the address bus of said microprocessor allowing to know the value of the program counter and a control memory containing verification information, wherein said supervisor module comprises a historical memory of the program counter indicating the position of the program counter while executing the previous instruction, and reading means of a verification information from said control memory defining for the current instruction, the allowed previous value of the program counter, said supervisor module comprising means to compare this verification information with the one coming from the historical memory, and means to generate an error if the comparison indicates an incompatibly.

8. Supervisor module according to claim 7, wherein the verification information contains at least two states, namely “access by auto-increment or “access by jump”, and in that the historical memory contains two states, namely “access by auto-increment” or “access by jump” on the basis of the behaviour of the program counter in order to reach the instruction in progress, the verification module generates an error if the verification information indicates the state “access by auto-increment”, and the historical memory indicates the state “access by jump”.

9. Supervisor module according to claim 7, wherein the verification information contains at least two states, namely “access by auto-increment” or “access by jump”, and in that the historical memory contains two states, namely “access by auto-increment” or “access by jump” on the basis of the behaviour of the program counter in order to reach the instruction in progress, the verification module accepts the current instruction if the verification information indicates the state “access by jump”, and the historical memory indicates the state “access by auto-increment”.
